(19) United States
(12) Patent Application Publication
(10) Pub. No.: US 2018/0075302 A1
(43) Pub. Date: Mar. 15, 2018

(54) Wayfinding and Obstacle Avoidance System

(71) Applicant: Float, LLC, Morton, IL (US)

(72) Inventors: Chad E. Udell, Metamora, IL (US); Seamas J. McGettrick, Metamora, IL (US); Steven P. Richey, Morton, IL (US); Travis A. Sauder, Bloomington, IL (US); Matthew E. Forcum, West Peoria, IL (US); Benjamin J. Aberle, Washington, IL (US)

(21) Appl. No.: 15/705,663

(22) Filed: Sep. 15, 2017

Related U.S. Application Data
(60) Provisional application No. 62/394,848, filed on Sep. 15, 2016.

(51) Int. Cl. G06K 9/00; G06T 7/521; G09B 21/00

(52) U.S. Cl. CPC G06K 9/00671; G06K 9/00214; G06T 7/521; G06T 2207/10028; G09B 21/006; G09B 21/003; G06T 2207/10048; G09B 21/008

(57) ABSTRACT

A wayfinding and obstacle avoidance system for assisting the visually impaired with wayfinding and obstacle avoidance. The wayfinding and obstacle avoidance system generally includes a processor, a memory, which stores program instructions, and potentially an area map. The wayfinding device is generally configured to receive pose data and depth data from a provider in order to determine the position of one or more objects within the field of view of the wayfinding device. This determination is usually made using interpreters, that may include a memoryless interpreter, a persistent interpreter, and a system interpreter. Interpreters will generally provide this information to a user via one or more presenters. This feedback may include, but is not limited to visual feedback, audio feedback, and haptic feedback.

### CROSS REFERENCE TO RELATED APPLICATIONS

I hereby claim benefit under Title 35, United States Code, Section 119(e) of U.S. provisional patent application Ser. No. 62/394,848 filed Sep. 15, 2016. The 62/394,848 application is currently pending. The 62/394,848 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to tools for wayfinding and obstacle avoidance for the visually impaired.

One of the problems associated with typical computer vision applications is uniform performance in outdoor and indoor applications. However, the conditions associated with these two environments are very different and require different solutions to optimally identify the position and orientation of potential obstacles for the vision-impaired. Moreover, typical systems for assisting the vision-impaired fail to address the issue of high/low object detection. In particular, the space in front of a user may be open with the exception of an object at head level such as a hanging plant or chandelier. Systems that consider the entire space to be obstructed may cause unnecessary wayfinding around the space which is mostly unobstructed and could be navigated simply by ducking. Alternatively, systems that ignore such obstacles because the space is mostly unobstructed could potentially result in head injury. Similarly, the path of a visually impaired person may be obstructed by low obstacles like chairs or raised door frames. In the case of door frames, alternate paths may not be available, such that a visually-impaired person would be forced to probe unfamiliar surroundings to make this determination this fact. Alternatively, one might assume the risk of tripping over an avoidable obstacle. In the case of chairs, recognizing the presence of a low obstacle might by desirable if a chair or other seating surface is sought

### Related Art

Any discussion of the related art throughout the specification should in no way be considered as an admission that such related art is widely known or forms part of common general knowledge in the field.

Existing object detection mechanisms have various limitations that are overcome by the disclosed wayfinding and obstacle avoidance system. Some systems utilize ultrasonic waves but are limited to detecting objects that are directly in front of them as opposed to an entire area. Other systems make no attempt to calculate depth and instead use image brightness to gives some indication of real world form.

### SUMMARY

An example embodiment is directed to a wayfinding and obstacle avoidance system. The wayfinding and obstacle avoidance system includes a device comprising a means for obtaining depth data indicating the distance and direction of a plurality of points within a field of view of the device; a means for providing sensory feedback; a processor; and a memory comprising program instructions that when executed by the processor cause the device to: acquire a point cloud, wherein the point cloud comprises a plurality of points indicating the position of the plurality of points relative to a frame of reference; group pluralities of normalized points in the normalized point cloud that are in close proximity to each other; reject groups containing a number of normalized points below a threshold; categorize any non-rejected groups as at least part of an object; and using the means for providing sensory feedback, produce a sensory representation of the presence of at least one object within the field of view of the device. Some embodiments may include a means for obtaining pose data indicating the orientation and position of the device; and a memory comprising program instructions that when executed by the processor cause the device to: acquire a normalized point cloud, wherein the normalized point cloud comprises a plurality of normalized points indicating the position and height of the plurality of points relative to a plane of reference; categorize at least one object as matching at least one type within a set of predefined types; and create an area map comprising a representation of the position of at least one object relative to the device, and at least one type for the at least one object.

There has thus been outlined, rather broadly, some of the embodiments of the wayfinding and obstacle avoidance system in order that the detailed description thereof may be better understood, and in order that the present contribution to the art may be better appreciated. There are additional embodiments of the wayfinding and obstacle avoidance system that will be described hereinafter and that will form the subject matter of the claims appended hereto. In this respect, before explaining at least one embodiment of the wayfinding and obstacle avoidance system in detail, it is to be understood that the wayfinding and obstacle avoidance system is not limited in its application to the details of construction or to the arrangements of the components set forth in the following description or illustrated in the drawings. The wayfinding and obstacle avoidance system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIGS. 1A and 1B contain front and back views of an exemplary wayfinding device.

FIG. 2 illustrates and exemplary visual display for an embodiment of a wayfinding device.

FIG. 3 illustrates a functional diagram of an exemplary wayfinding device.

FIG. 4 illustrates an exemplary process flow for a wayfinding device.

FIG. 5 illustrates an exemplary method for automatically changing the provider of depth and pose data for use with a wayfinding device.

FIGS. 6A to 6H illustrate exemplary visual displays for a wayfinding device showing various sample outputs.

FIG. 7 illustrates a vest suitable for use with an exemplary wayfinding and obstacle avoidance system.

FIG. 8 illustrates a lanyard suitable for use with an exemplary wayfinding and obstacle avoidance system.

FIG. 9 illustrates bone-conduction headphones suitable for use with an exemplary wayfinding and obstacle avoidance system.

FIG. 10 illustrates an individual wearing a vest containing an exemplary wayfinding device that is connected to a pair of bone-conducting headphones.

FIGS. 11A to 11C illustrate the use of a wayfinding device to determine the relative orientation and position of a table at there different locations.

FIGS. 12A to 12B illustrate the use of a wayfinding and obtracle avoidance system to determine the height of potential obstacles.

FIGS. 13A to 13F illustrate the measurement of object height at different distances from a user of a wayfinding and obstacle avoidance system. FIG. 13G illustrates detection of an object that is not within the field of view of the user.

FIG. 14 illustrates a typical environment for the use of a wayfinding and obstacle avoidance system

FIG. 15 illustrates a visualization of a point cloud for the scene depicted in FIG. 14.

### DETAILED DESCRIPTION

### A. Overview

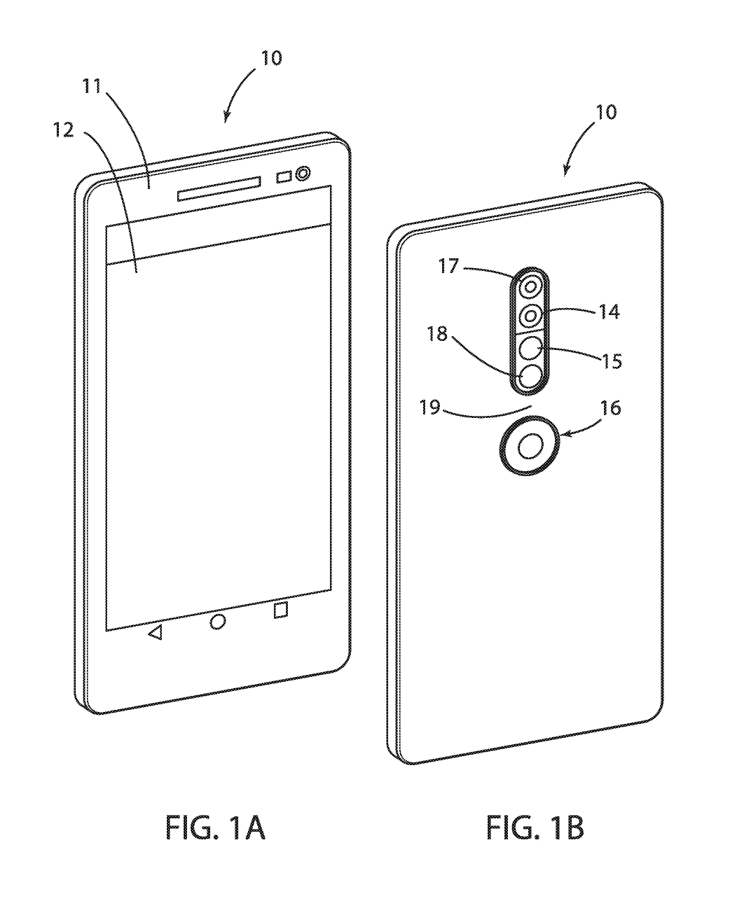

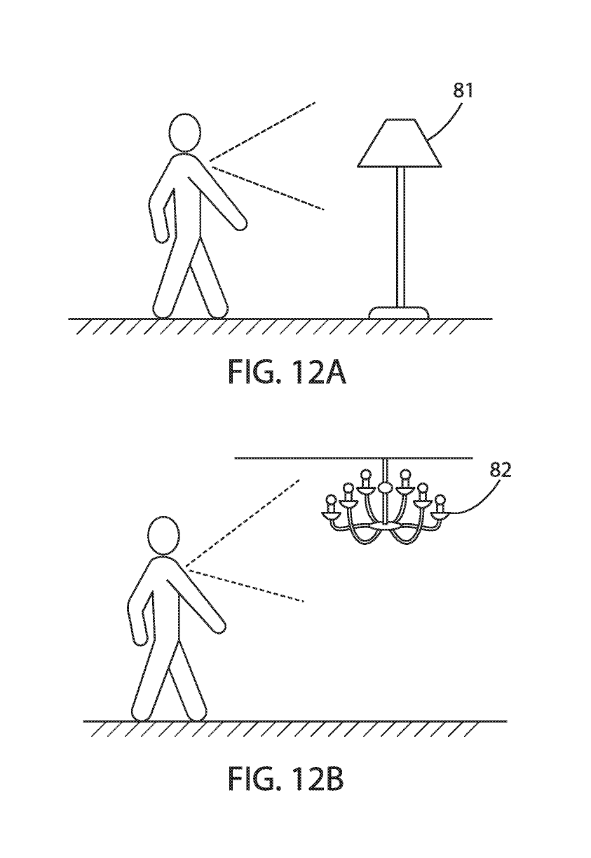

Turning now descriptively to the drawings, in which similar reference characters denote similar elements throughout the several views, FIGS. 1A through 15 illustrate the displays and operation of an exemplary wayfinding and obstacle avoidance system. A wayfinding and obstacle avoidance system generally includes a wayfinding device 10. Wayfinding device 10 generally comprises a processor 20, memory 21, which stores program instruction 51, and potentially an area map 52. The wayfinding device 10 is generally configured to receive pose data 31 and depth data 32 from a provider 30 in order to determine the location of one or more objects within the field of view of the wayfinding device 10. This determination is usually made using interpreters 34, that may comprise a memoryless interpreter 35, a persistent interpreter 36, and a system interpreter 37. Interpreters 34 will generally provide this information as feedback to user via one or more presenters 38. This feedback may include, but is not limited to visual feedback, audio feedback, and haptic feedback. This feedback may also be generated within the wayfinding device 10 or via an external device directly or indirectly.

### B. Mobile Device

Wayfinding device 10 is generally a mobile device. A mobile device may be comprised of any type of computer for practicing the various aspects of the wayfinding and obstacle avoidance system. For example, the mobile device can be a personal computer (e.g. APPLE® based computer, an IBM based computer, or compatible thereof) or tablet computer (e.g. IPAD®). The mobile device may also be comprised of various other electronic devices capable of sending and receiving electronic data including but not limited to smartphones, mobile phones, telephones, personal digital assistants (PDAs), mobile electronic devices, handheld wireless devices, two-way radios, augmented reality googles, wearable devices, communicators, video viewing units, television units, television receivers, cable television receivers, pagers, communication devices, unmanned vehicles, and digital satellite receiver units.

The mobile device may be comprised of any conventional computer. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the wayfinding and obstacle avoidance system. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor together with an operating system operate to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

### C. Wayfinding Device 10

FIG. 1 illustrates an exemplary wayfinding device 10 that can be used as part of a wayfinding and obstacle avoidance system. This exemplary device is a Lenovo Tango Phab 2 Pro. However, other devices can be used as part of wayfinding and obstacle avoidance system. The wayfinding device 10 in FIGS. 1A and 1B includes a frame 11, and a touchscreen 12 that can also serve as a display. As shown in FIG. 1B, the rear of wayfinding device 10 may include an infrared sensor 14, an infrared emitter 15, a fisheye motion camera 16, a still image camera 17, a flash 18, and a microphone 19. Flash 18 can be used to provide visible light when necessary for the operation of wayfinding device 10. Although flash 18 is described as a “flash”, it may also be capable of continuous operation like a flashlight.

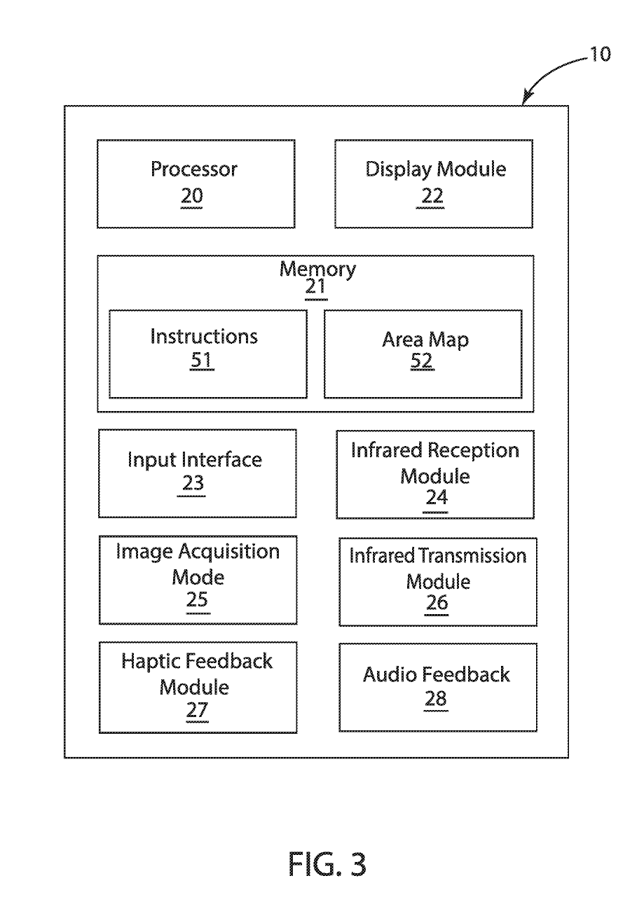

FIG. 3 is a functional diagram of wayfinding device 10, which includes a processor 20, memory 21, a display module 22, an input interface 23, an infrared reception module 24, an image acquisition module 25, an infrared transmission module 26, a haptic feedback module 27, and an audio feedback module 28. Processor 20 executes the functionality of wayfinding device 10 in accordance with program instructions 51 stored within memory 21. Memory 21 may also comprise an area map 52 representing the location of objects within a region like a room or within a certain distance of the wayfinding device 10. The display module 22 interfaces with touchscreen 12 to control the display of wayfinding device 10. The input interface 23 receives data from touchscreen 12, any buttons that may be present in frame 11, and potentially microphone 19. The infrared reception module 24 interfaces with infrared sensor 14 to interpret and receive reflections of infrared light initiated by infrared transmission module 26 using infrared emitter 15. In particular, infrared reception module 24 and infrared transmission module 26 may coordinate to determine the time between an emission of infrared light and receipt of the reflection caused by this emission. Wayfinding device 10 may also include an image acquisition module 25 that interfaces with still image camera 17 and fisheye motion camera 16. If still-image camera 17 is an RGB camera, the image acquisition module 25 may acquire three separate images corresponding to red, green, and blue. Image acquisition module 25 may also interpret the data from still image camera 17 and fisheye motion camera 16 in a manner that contains metadata reflecting motions or other visually obtainable information that is not strictly part of an image. To the extent that the effectiveness of still image camera 17 or fisheye motion camera 16 is adversely affected by low-light conditions, flash 18 can be used to ameliorate this problem. Flash 18 may be controlled via the image acquisition module 25 or directly by processor 20.

Wayfinding device 10 may also include a haptic feedback module 27, which controls the operation of a vibration motor (not shown) that provides feedback to a user by causing the wayfinding device 10 to vibrate. Wayfinding device 10 may also include an audio feedback module 28 to provide audio feedback to a user. The output of audio feedback module 28 may not be strictly audible in a lay sense because it may interface with bone conduction headphones 72. Wayfinding device 10 may include other sensors, including but not limited to, an accelerometer, a gyroscope, level sensors, and a compass. Wayfinding device 10 may include other forms of output including, but not limited to: activation of servomotors, and wireless transmissions.

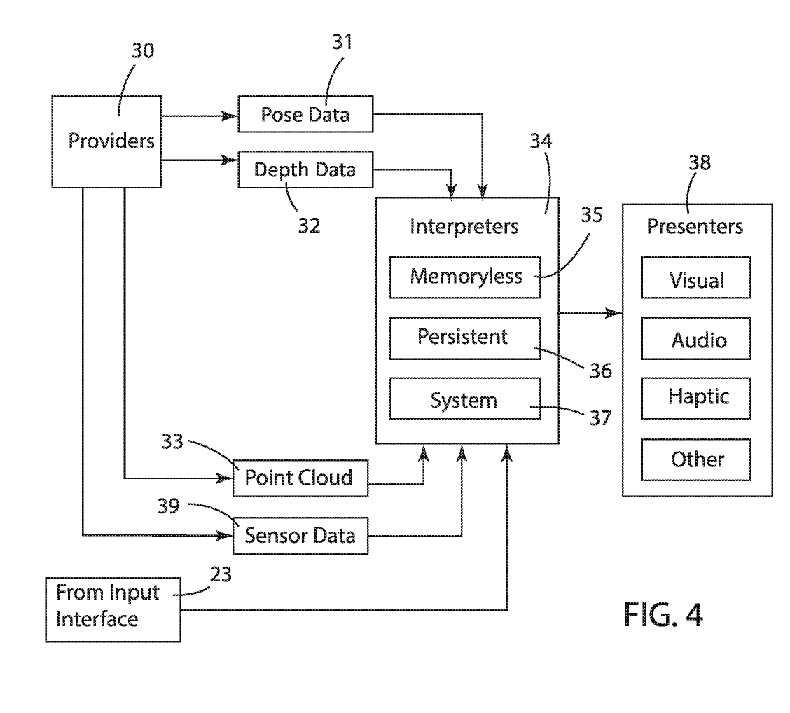

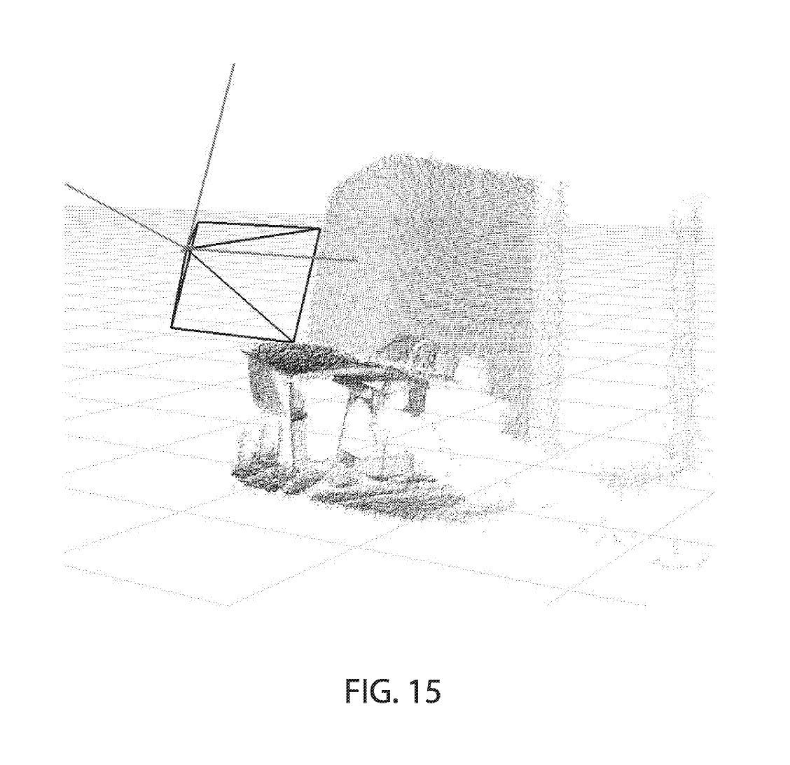

FIG. 4 illustrates the operation of an embodiment of a wayfinding and obstacle avoidance system. A wayfinding and obstacle avoidance system generally relies on the acquisition of depth data 32 and pose data 31 corresponding to wayfinding device 10 and its surrounding environment. Depth data 32 refers to the distance between the wayfinding device 10 and any obstacles that may be detected within its field of view. Pose data 31 refers to the orientation of the wayfinding device 10 with respect to the horizontal, and establishes a reference point for depth data 32. Pose data 31 and depth data 32 can be represented in a point cloud 33 such as the visualization of one shown in FIG. 15. Each point represents a single distance measurement with respect to a specific point within the field of view of the wayfinding device 10. In the visualization shown in FIG. 15, darker shaded-points indicate points that are closer to a reference point(i.e., has a low depth), and lighter shaded-points indicate points that are farther from the reference point distances (i.e., have a high depth). However, the absence of a point does not represent maximum lightness (i.e., maximum depth). The absence of a shaded-point simply indicates the inability to obtain an accurate measurement, which could be caused by factors other than being out of range. For example, there may be no object within range, or there may be an object that distorts or interferes with reflections of infrared light in ways that are difficult to detect. Also, the detection of the reflected infrared light may be impeded by overwhelming sources of infrared radiation like a stove or the sun.

The point cloud 33 visualized in FIG. 15 is based on the scene shown in FIG. 14, which contains a table and chairs including a high chair. The visualization in FIG. 15 is based on depth measurements originating at the apex of the square pyramid with a field of view in accordance with the shape of that pyramid.

The embodiment of a wayfinding and obstacle avoidance system illustrated in FIG. 4 operates in the following manner. One or more providers 30 are used to obtain pose data 31 and depth data 32. In some embodiments, pose data 31 and depth data 32 are converted into a normalized point cloud 33 by interpreter 34. A normalized point cloud 33 uses a specific frame of reference, which is usually the horizontal. In contrast, depth data 32 is based on the field of view when the data is obtained, which generally uses the orientation of the wayfinding device 10 as a frame of reference. In other embodiments, a provider 30 transfers the data to an interpreter 34 already in the form of a normalized point cloud 33. In addition, interpreter 34 can be configured to utilize other sensor data 39 such as an accelerometer, gyroscope, or compass, all of which can provide information relevant to wayfinding and obstacle avoidance. In addition, an interpreter 34 may be configured to handle user inputs, such as a button on frame 11 or the touchscreen of display 12. User inputs may also include audio commands from the user via microphone 19. Using interpreter 34, wayfinding device 10 determines the location of objects indicated within the received data. This object information can then be presented using one or more presenters 38. This object information may be presented to a user of the wayfinding device 10 in the form of visual, audio, and/or haptic feedback, for example. In addition, presenter 38 may transmit this object information to remote locations, store it locally, or integrate it within an area map 52, for example.

### D. Providers 30

A wayfinding and obstacle avoidance system may include one or more providers 30 for use in object detection. In addition, different providers 30 may be used depending on the operating environment of the wayfinding device 10. For example, some providers 30 of pose data 31 and depth data 32 are better when used indoors, and other providers 30 may be better suited for use outdoors. In addition, providers 30 may vary in terms of the quantity, frequency, type, and quality of data that is provided. In addition, redundant or duplicative sources of pose data 31 and depth data 32 can be used simultaneously, possibly to provide finer detection resolution, or to utilize the strengths of different providers 30. For example, current pose data 31 can be inferred based on a comparative analysis between the current depth data 32 and previously collected depth data 32. However, if wayfinding device 10 provides additional sensor data 39 from position and/or orientation sensors, for example, this sensor data 39 may be used in lieu of or in addition to inferred pose data 31. Other providers 30 that can be used with the disclosed wayfinding and obstacle avoidance system include, but are not limited to: 3D cameras (i.e., stereo cameras), ultrasonic sensors, feature tracking, single image cameras, fisheye cameras, and external data feeds, possibly originating with an external LIDAR device.

### Tango Provider

The Tango provider relies on the use of infrared emitters 15 and infrared sensors 14 and is best suited for use indoors. Generally speaking, it operates by generating a sequence of infrared pulses, typically using a frustrum shape, such as the square pyramid shown in FIG. 15. This infrared light will create reflections upon contact with objects in its path. These reflections can be detected by an infrared sensor 14, which may or may not be integrated with the infrared emitter 15 or other sensors. Processor 20 within wayfinding device 10 interfaces with infrared sensor 14 via infrared reception module 24 and with infrared emitter 15 via infrared transmission module 26. The data corresponding to the direction and depth of each point is then placed within a point cloud 33 such as the one shown in FIG. 15. This point cloud 33 is essentially a series of points in three-dimensional space. In some cases, this data is determined using structure from motion. In other cases, this data is obtained using time-of-flight, as measured using infrared reception module 24 and infrared transmission module 26. However, other methods of creating a point cloud 33 are suitable for use with a wayfinding and obstacle avoidance system. The point cloud 33 produced by Provider 30 can then be passed to interpreters 34.

### Single Camera Simultaneous Localization and Mapping (SLAM)

Another method for obtaining pose data 31 and depth data 32 includes analyzing still images to determine the depth of objects within that single image. The process described in this embodiment can be referred to as Single Camera Simultaneous Localization and Mapping, or Single Camera SLAM, for short. This type of provider 30 can be useful in outdoor situations where alternate sources of infrared radiation, like the sun, for example, can make the Tango method ineffective. However, Single Camera SLAM can also be used indoors, if desired. One Single Camera SLAM method is based on the creation of a neural network that is trained to identify commonly viewed outdoor objects. For example, the TensorFlow program (https://www.tensorflow.org) can be used to create a neutral network and then trained using the KITTI dataset (available at http://www.cvlibs.net/datasets/kitti). The KITTI Dataset focuses on outdoor scenes, which is the expected environment in which this provider would be used in lieu of the Tango provider. However, other datasets can be used to accommodate different environments or for consistency checking.

In one embodiment utilizing the Single Camera SLAM method, the process begins with a 320×240×3 image, meaning that it is 320 pixels wide, 240 pixels tall, and comprised of three channels (e.g., red, green, and blue). This image can be processed in chunks via convolution and resized several times to produce a 40×30×384 data structure. This data structure is then resized to produce an 80×60×1 image which is essentially a depth map of the entire input image. Using the training data, the network can make a reasonable estimate of how far away objects are in the image. Additional information regarding this method is described in the paper, Depth Map Prediction from a Single Image using a Multi-Scale Deep Network, a joint research paper by Facebook Al Research and NYU (Authors: David Eigen, Christian Puhrsch, and Rob Fergus; Jun. 9, 2014; available at https://arxiv.org/pdf/1406.2283.pdf), which is incorporated by reference.

Although a wayfinding and obstacle avoidance system can be used with other methods of obtaining pose data 31 and depth data 32, the Single Camera SLAM method does have certain advantages over alternate methods such as feature tracking, structure from motion, motion stereo, and plane sweep stereo. For example, feature tracking works best when the camera is in a fixed location, while motion stereo is best suited for situations where the camera is moved only in a single direction. It is expected that users of the disclosed wayfinding and obstacle avoidance system will use it while walking, which implies that there will be unpredictable and varied left-to-right motion with some variable forward momentum. The Single Camera SLAM method avoids these motion problems. In addition, it has the advantage of using a single camera, such as a still image camera 17 as shown in FIG. 1B.

### Other Providers

In addition to the Tango provider and a Single Camera SLAM provider discussed above, other providers 30 can be used, including the less advantageous ones discussed above. Other providers 30 may rely on LIDAR, o ultrasonics, for example. In addition, providers 30 may comprise commercial solutions such as ARCore, ARKit, Structure Sensor, and Buzzclip. Moreover, the data sent to interpreters 34 from providers 30 may comprise data originating from test data or an arbitrary data feed. Providers 30 can also include sensor data 39 obtained from internal sensors of a wayfinding device 10 that may not actually produce pose data 31 or depth data 32. However, sensor data 39, such as from orientation and position sensors within a wayfinding device 10, may be useful in analyzing pose data 31 and depth data 32.

### E. Interpreters 34

The interpreters 34 process the data received from providers 30 such that appropriate feedback is provided to the presenters 38. In this embodiment, interpreters 34 include a memoryless interpreter 35, a persistent interpreter 36 and/or a system interpreter 37. However, other interpreters 34 can be used with a wayfinding and obstacle avoidance system. In general, the specific instances of an interpreter 34 do not communicate with each other. However, multiple instances of interpreter 34 can be used in parallel. For example, a memoryless interpreter 35 and a persistent interpreter 36 may act independently on identical data from a provider 30. A wayfinding and obstacle avoidance system may also use multiple instances of the same class of interpreter 34 simultaneously, with some using the same provider 30 and with others using different providers 30.

### Memoryless Interpreter 35

The memoryless interpreter 35 produces feedback based on the presently observed conditions. In general, this includes converting the most recently obtained pose data 31 and depth data 32 into appropriate feedback for the user of wayfinding device 10 via a presenter 38. A memoryless interpreter 35 may convert the pose data 31 and depth data 32 into a normalized point cloud 33 before submitting feedback to a presenter 38. In one embodiment, depth data 32 is processed to form groupings that, if sufficiently large, are treated as obstacles that may require guidance to avoid.

### Persistent Interpreter 36

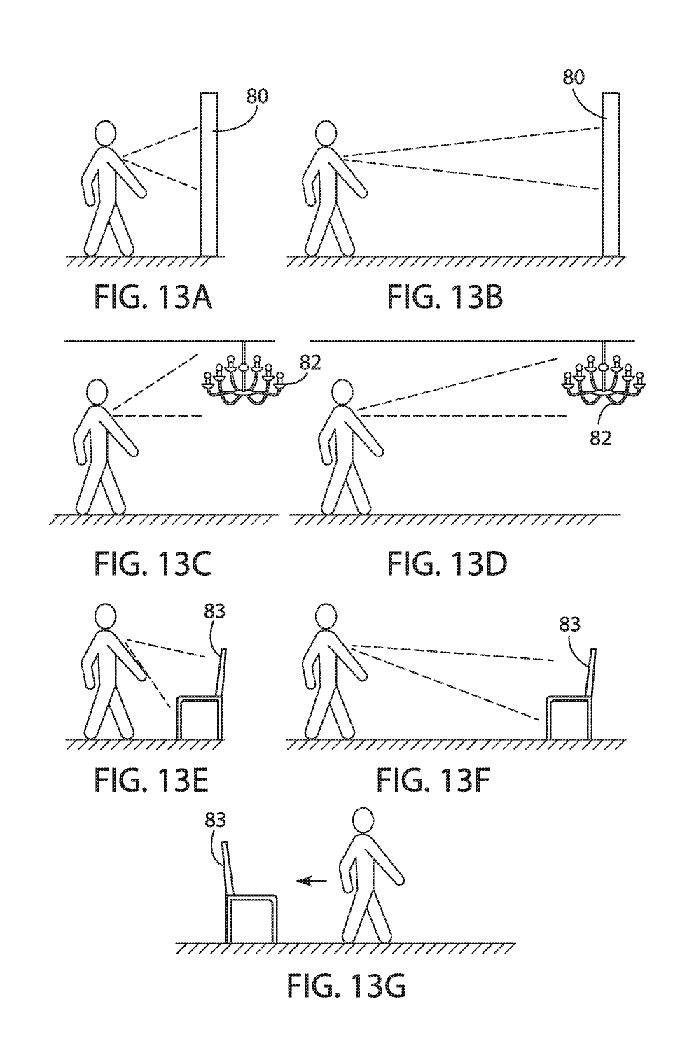

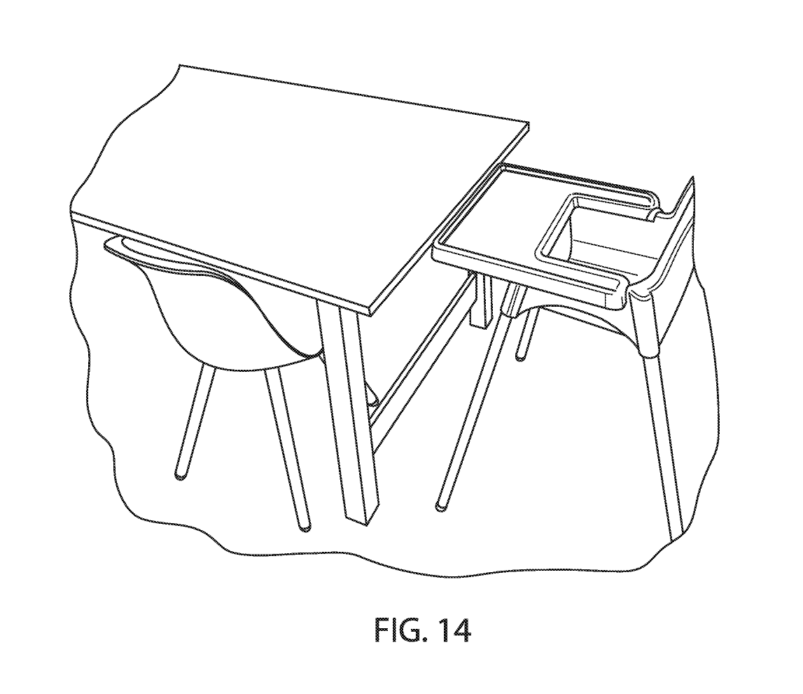

The persistent interpreter 36 produces feedback based at least in part on information previously obtained about the surrounding environment. For example, a user's proximity to an object determined to be a head hazard or a tripping hazard can be determined based on a user's location within an area even if the hazard is no longer in the field of view of wayfinding device 10. For example, as the user approaches a potential tripping hazard, it may drop below the field of view. which generally doesn't include the user's feet. he wayfinding device may A persistent interpreter 37 generally stores a sparse 3D representation of some of the objects within the surrounding environment. Area map 52 is considered to be a sparse representation because it does not need to include all available information about the surrounding area. It only includes information regarding the position of selected objects. The objects in the area map 52 can be used to indicate the proximity of objects that are not in view. For example, FIG. 13G illustrates a user walking backwards towards a chair 83. Wayfinding device 10 can provide an indication to the user who may be unware that there is chair behind him or her.

In some embodiments, persistent interpreter 36 will classify any identified objects according to a type. In some embodiments, area map 52 contains only objects that are classified as at least one of: a high object, a low object, a stairs object, a wall object, a doorway. Area map 52 may also include points of interest and/or wayfinding points. The area map 52 produced by the persistent interpreter 36 may not have a fixed spatial location (e.g., a particular room or building). In some embodiments, the area map 52 is based on contains objects that are within a specific radius of wayfinding device 10, such as 5 meters, for example. In other words, area map 52 will be updated with new objects as they are identified and classified, but objects that are no longer within 5 meters are removed from the area map 52 once they are out of range. In other embodiments, new object locations are assigned an expiration date/time, and will remain stored in the area map 52 until the time expires. If the object's location is detected at a subsequent time, its expiration date/time can be reset. Similarly, if it is determined that a previously identified object is no longer present, it can be removed from the area map 52 before expiration.

FIGS. 13A to FIG. 13F illustrate various scenarios in which an area map might be utilized. The user possesses a wayfinding device 10 at chest level, which is not shown for purposes of clarity. FIGS. 13A and FIG. 13B illustrate detection of a wall 80 as an obstacle. Because it spans the height of the user, this obstacle could be stored as a wall object in the area map 52, but would not be considered either high object or low object. FIG. 13C and FIG. 13D illustrate a chandelier 82 as a high object which presents a head bumping hazard, and would be stored in the area map 52 as such. FIGS. 13E and FIG. 13F illustrate a chair 83 which could potentially be low object (i.e., tripping hazard) depending on the height of the low threshold. If the wayfinding device 10 were configured to do so, chair 83 could be stored in the area map as a chair object in lieu of or in addition to being stored as a low object. FIG. 13G illustrates the use of the persistent interpreter 36 to provide an indication corresponding to proximity of chair 83 even though the user and his wayfinding device 10 are facing away from it.

System Interpreter 37 System interpreter 37 is used to monitor system state conditions that are not directly related to object detection. For example, system interpreter 37 may receive and respond to user inputs or commands. User commands might include a request to switch providers 30 for pose data 31 and/or depth data 32, a request to tune adjustable variables such as detection sensitivity, warning ranges, high/low definitions, or a request to pause or resume operation.

As described above, the Tango method is generally advantageous when used indoors and the Single Camera SLAM method can be advantageously used both indoors and outdoors. Therefore, optimal usage may require switching methods when transitioning between different environments, such as indoors and outdoors. Moreover, the effectiveness of a provider 30 may vary even without changing locations. For example, a certain room may receive more natural light during different times of day. System interpreter 37 can be configured to automatically select an appropriate provider 30 without user input. Of course, the provider 30 can also be selected based on direct user selection via input interface 23. Furthermore, the system interpreter 37 can automatically suspend the operation of presenters 38, if it detects that wayfinding device 10 has been stationary for too long, for example.

In one embodiment of a wayfinding and obstacle avoidance system, a wayfinding device 10 is configured to use a Tango-based provider whenever practicable and to automatically switch to a different provider 30 whenever the Tango method becomes ineffective. Ineffectiveness is determined based on the number of objects detected by the Tango method. A point cloud 33 produced by the Tango method will generally comprise numerous groupings of points (or hits). If the number of hits drops below a certain number, this can be an indication that the Tango method is no longer effective. In addition, even if numerous groupings are detected, there may be empty regions that indicate a potential problem with the efficacy of the Tango method. For example, in the case of a short hallway, a point cloud 33 generated based on a wayfinding device 10 oriented down the hallway may comprise a region with points that have a low measured depths corresponding to the area around the entrance to the hallway and a region with points that have high measured depths corresponding to the end of the hallway and the connecting walls. Because there are measured pixels in both regions, one can be reasonably confident that there are no undetected obstructions in the hallway. However, a region without any detected points may have causes other than the absence of objects. For example, there may be some form of interference that prevents the reflections of infrared light from being measured, such as sunlight from a window at the end of the hallway. Another possibility is that an undetected obstacle has altered the infrared reflections in a manner that prevents their detection by an infrared sensor 14. Thus, the absence of detected points may indicate the need for an alternate method for obtaining depth data.

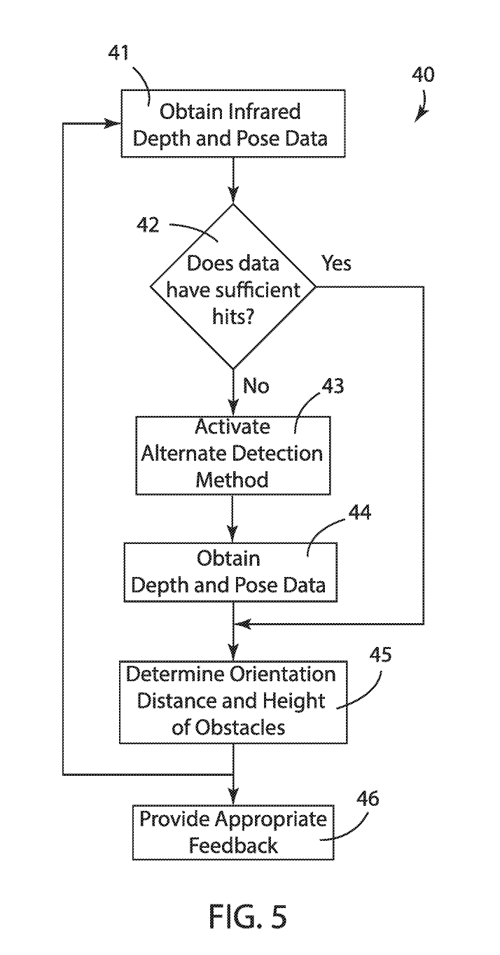

FIG. 5 illustrates an exemplary process 40 that can be used by the system interpreter 37 to automatically change providers 30 for pose data 31 and depth data 32 based on data quality. In this embodiment, the wayfinding device 10 is configured to use the Tango provider unless it receives insufficient data. If wayfinding device 10 receives an insufficient number of hits it will switch to the Single Camera SLAM method for the duration of this insufficiency. At step 41, the memoryless interpreter 35 of wayfinding device 10 will obtain pose data 31 and depth data 32 using Tango. After the data has been received, the system interpreter 37 will determine if the data had sufficient hits at step 42. If sufficient hits were received, at step 45, the memoryless interpreter 35 will proceed to determine the distance and direction of any obstacles. However, if insufficient hits were obtained, the system interpreter 37 will activate an alternate depth detection method, such as Single Camera SLAM, at step 43. Using this new provider 30, pose data 31 and depth data 32 will be obtained at step 44. At this point, the process continues to step 45, where the memoryless interpreter 35 will proceed to determine the direction and distance of any obstacles. Based on this determination, appropriate feedback will be provided to the user at step 46. In this embodiment, the process repeats at step 41, which means that the Tango provider will be tested at every iteration, which ensures that it will be used as much as practicable.

### F. Presenters 38

The result of interpreter 34 is sent to presenters 38 to provide feedback to the user and may also store the object detection data at remote locations. A haptic presenter controls the operation of one or more vibration motors in a manner that will cause the wayfinding device 10 to vibrate. The pattern and intensity of haptic vibrations can be adjusted to provide different information. For example, in some embodiments, a distant object may produce a gentle and intermittent vibrations whereas a nearby object may result in high intensity vibrations in rapid succession.

### Visual Presenter

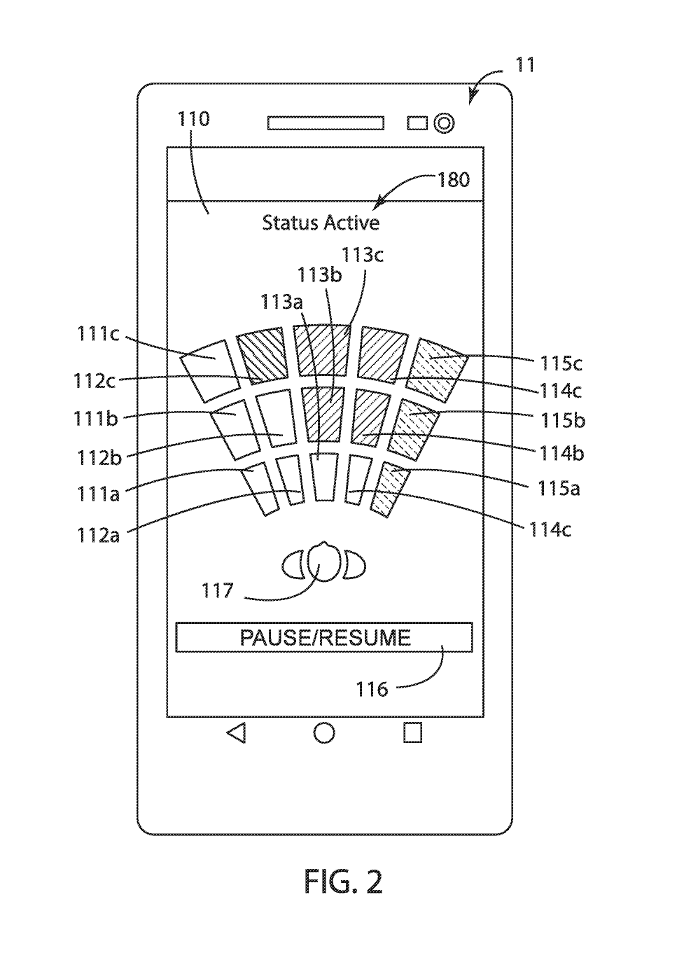

A visual presenter produces visual representations of object locations, such as the ones shown in FIGS. 2, 6A to 6H, and 11A to 11C. With respect to FIG. 2, visual display 110 shows a top-down view of the area surrounding the wayfinding device 10 that has been divided into 5 slices labeled from left to right 111, 112, 113, 114, and 115. Each slice is divided into 3 sub-slices designated a, b, or c. (e.g., 111a, 111b, or 111c). Element 117 represents the user of the wayfinding device 10 who is presumably holding the wayfinding device 10 near his/her body and facing outwards. In this embodiment, a nearby object located within a sub-slice will illuminate that sub-slice plus any more distant sub-slices. For example, slice 115 in FIG. 2 has illuminated sub slices 115a, 115b, 115c, which indicates that there is an obstacle in the region corresponding to 115a. This obstacle may or may not extend into regions corresponding to 115b or 115c, or there may be different obstacles in those regions. Generally, the presence of an object in a nearby region obscures the presence of objects in more distant regions, which makes this an appropriate indication. However, alternate embodiments may have access to data indicating the absence of objects in more distant regions, and may modify visual display 110 accordingly.

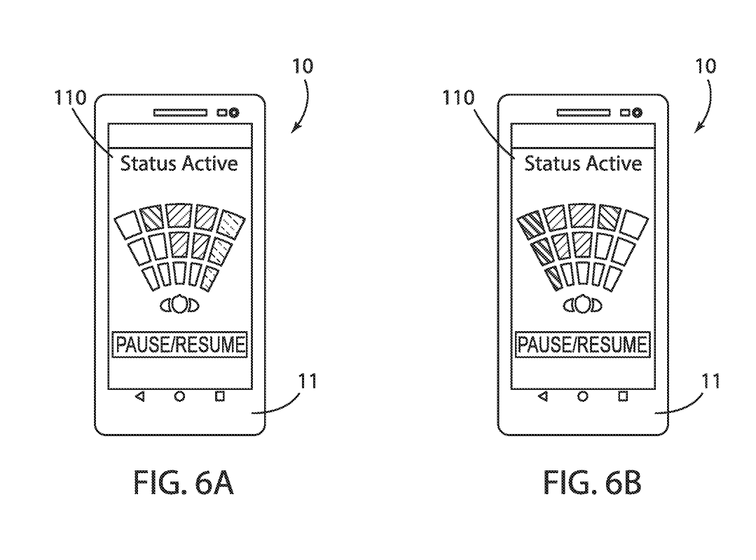

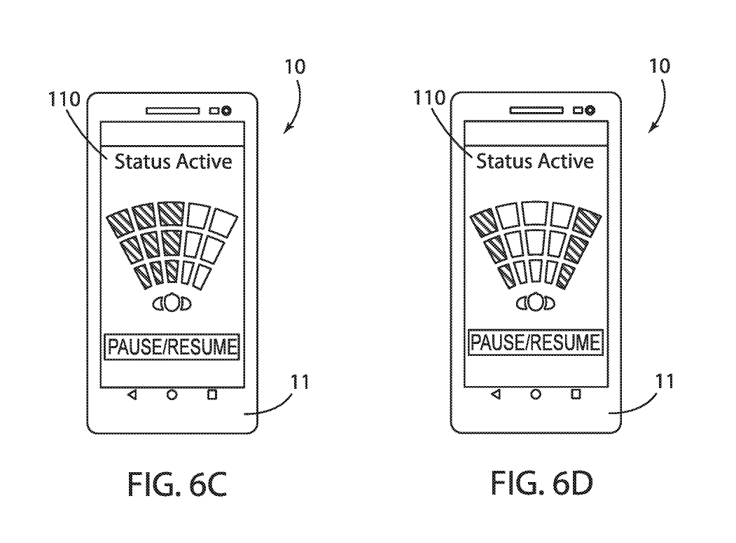

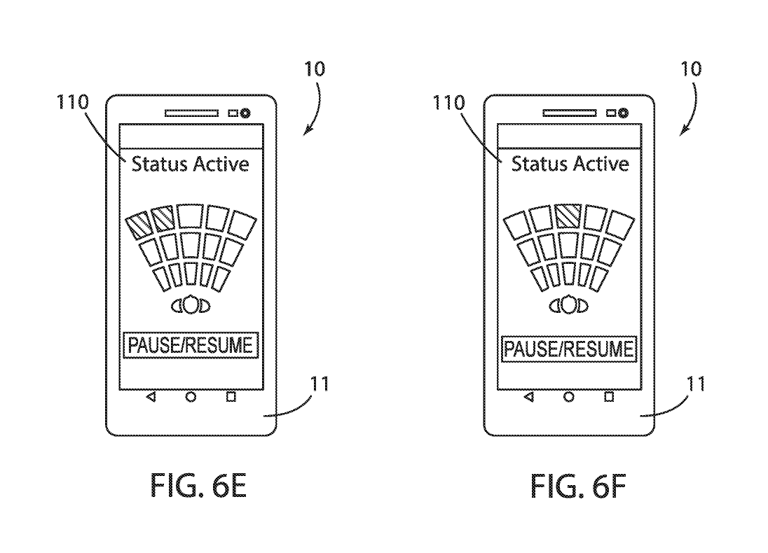

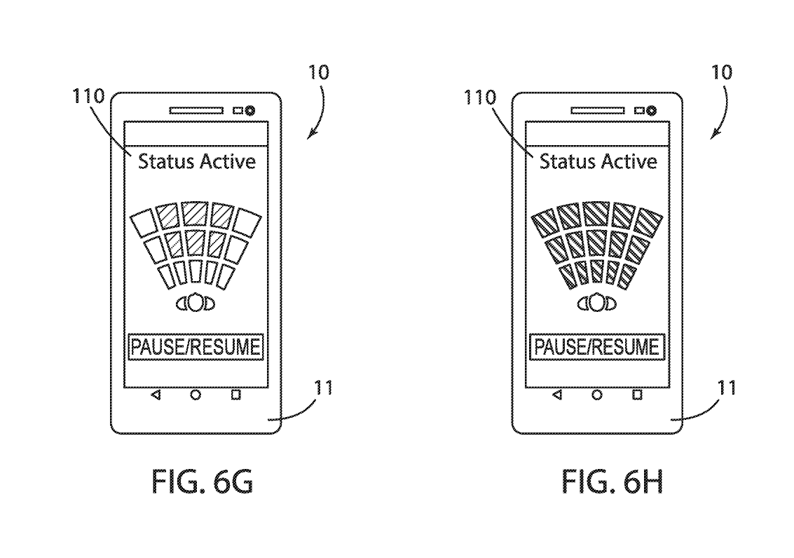

Because visual display 110 is presented relative to the facing of wayfinding device 10, its display may change to reflect alternate orientations. FIGS. 6A to 6H illustrate alternate displays that represent different configurations of objects in the region surrounding the wayfinding device. These figures are based on a user holding the wayfinding device 10 with the infrared sensor 14 and infrared emitter 15 directed directly away from the user. For example, if the object depicted in FIGS. 6A and 6B corresponds to the edge of a table, if the user r of the wayfinding device 10 depicted in FIG. 6A turns to the right, this may result in the visual display 110 indicated in FIG. 6B. FIGS. 6C and 6D illustrate navigation near a hallway. In FIG. 6C, the user is facing the wall near the entrance to the hallway. By turning to the right, the user is now facing down the hallway. FIGS. 6E, 6F, 6G, and 6H illustrate a visually-impaired user navigating towards a table. In FIG. 6E, the user is within range of the table, but not facing directly at it. In FIG. 6F, the user has turned to the left so that the table is now centered in the visual display 110. The difference in the number of slices indicated in FIGS. 6E and 6F reflects the possibility that an obstacle may not neatly align with the boundaries of a slice, such as 111 and 112. In this embodiment, the interpreter 34 has conservatively chosen to illuminate both slices 111 and 112 rather than indicate that a partially blocked slice is clear. After aligning with the table to produce the visual display 110 shown in FIG. 6F, the user may approach the table producing the visual displays 110 shown in FIGS. 6G and 6H, respectively. As the user approaches the table, the closer sub-slices are illuminated to indicate that the table is closer than before. In addition, the slices on either side are illuminated to indicate that the table occupies a larger portion of the field of view of wayfinding device 10. Finally, in FIG. 6H, the user is close enough to the table that all sub-slices 111a to 115c are illuminated indicating that the user has reached the table.

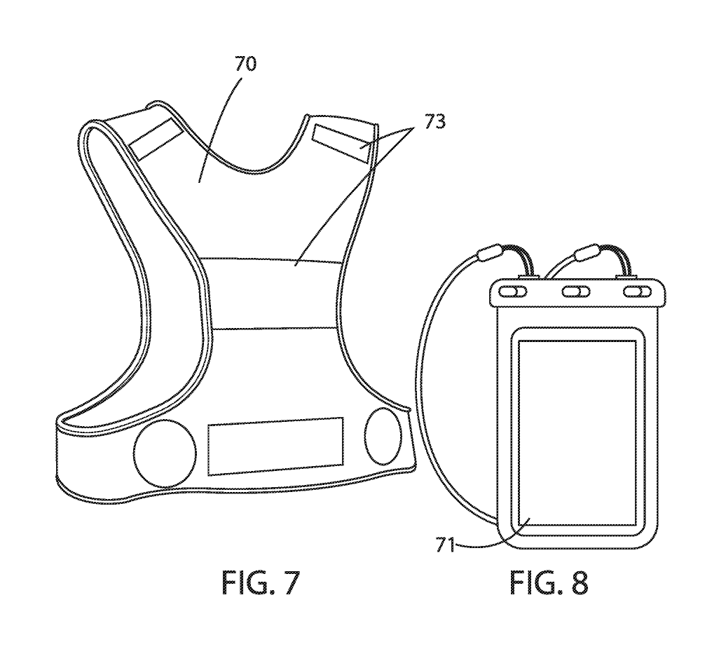

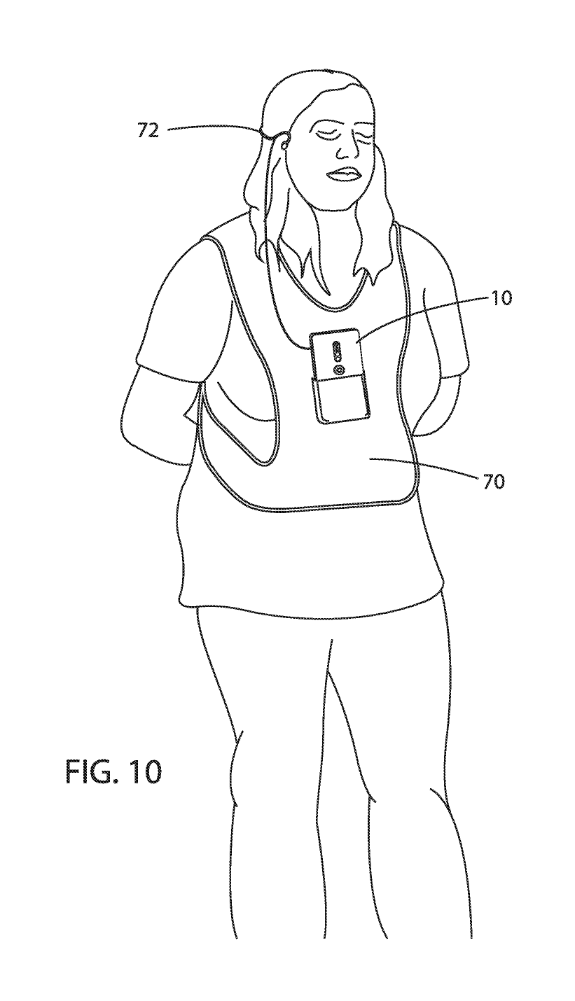

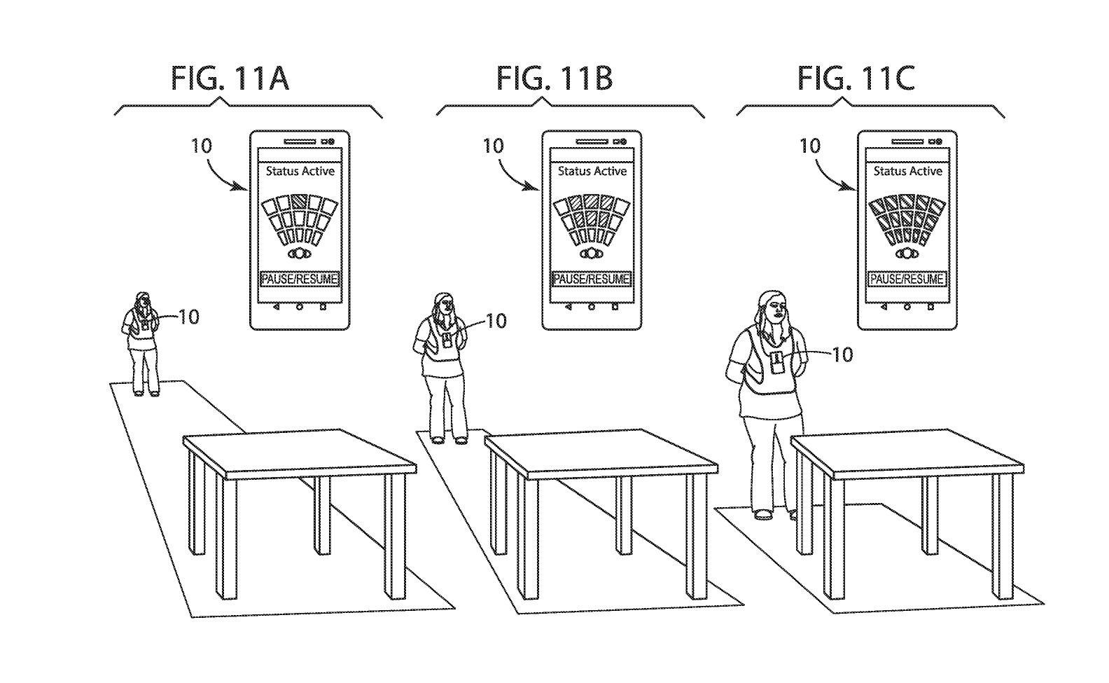

This process of using a wayfinding and obstacle avoidance system to approach a table is also illustrated in FIGS. 11A, 11B, and 11C. As the user approaches the table, the same visual displays 110 shown in FIGS. 6F to 6H are shown in FIGS. 11A to 11C. The user shown in FIGS. 11A to 11C is wearing the wayfinding device 10 within a vest 70. FIG. 7 illustrates an exemplary vest 70 for use with a wayfinding and obstacles avoidance system. For additional safety, vest 70 may include one or more reflective strips 73. FIG. 8 illustrates an exemplary lanyard 71 that can be used in lieu of vest 70 to support a wayfinding device 10.

### Audio Presenter

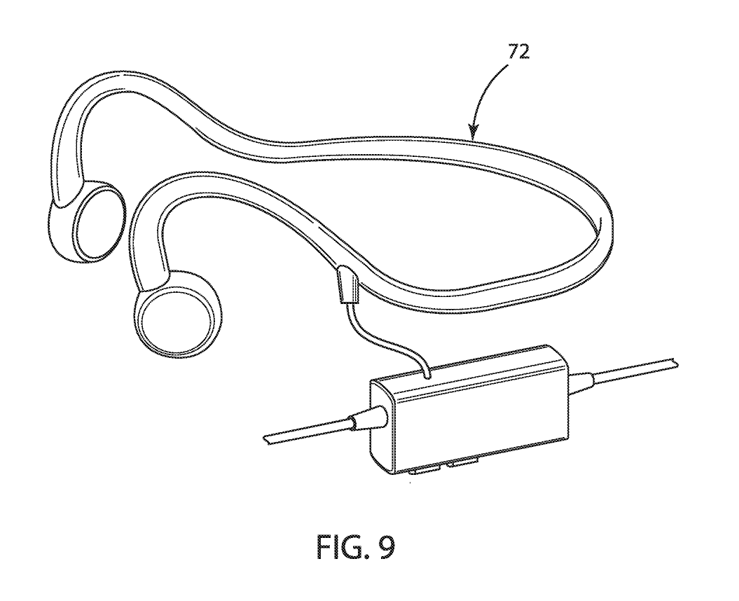

Audio presenter produces audio indications of the location of proximate objects using intermittent tones instead of a visual display 110. Audio indications are better suited for those whose visual-impairment does not permit any use of a visual display 110. In this embodiment, the audio presenter interfaces with a pair of bone conducting headphones 72 via audio feedback module 28. FIG. 9 illustrates an exemplary pair of bone-conducing headphones 72 suitable for use with a wayfinding and obstacles avoidance system. Bone-conducting headphones 72 have the advantage of not interfering with a user's normal hearing. However, the usage of bone-conducting headphones 72 is not necessary to utilize a wayfinding and obstacles avoidance system. In this embodiment, the audio signals produced via wayfinding device 10 comprise three distinct periodic tones representing objects on the left, right, and center, respectively. The left, right, and center regions for purposes of audio presentation may not align with the visual display 110. For example, the 5 slices shown in visual display 110 may collectively correspond to the center for purposes of audio feedback. In this embodiment, the volume and repetition frequency of the respective tones reflects the distance between the user and nearby objects. As the user moves closer to an obstacle, the tones increase in volume and speed of repetition.

In addition to left, right, and center indications, the audio presenter can produce specific tones reflecting whether a nearby object is high or low. In this embodiment, a high object refers to an object that is entirely within a height region defined as high. Any object that spill out of the high region can be treated like a complete obstruction. Similarly, a low object refers to objects that is entirely within a height region defined as low. The definition of the low region and high region can be manually or automatically changed as needed. In particular, the definition of the high region may need to be altered to reflect the height of the user, whose height generally exceeds the normal operating height of wayfinding device 10. The production of high and low indications may rely on previously stored data such as area map 52, as discussed above.

Audio presenter may also produce other indications related to the user of wayfinding device 10. For example, the audio presenter may be used to indicate that the wayfinding device has changed providers 30. This may occur, for example, when a user transitions from indoors to outdoors or vice versa. In addition, other indications can be provided such as the presence of fast moving nearby objects. In embodiments where wayfinding device 10 is a mobile phone, the audio presenter may be configured to relay any indications produced by other programs on the mobile phone.

### Other Presenters

In addition to the haptic, visual, and audio presenters, the object detection information produced by interpreter 34 can be presented to remote machines or other forms of storage. For example, the object detection information can be used to automatically operate a servomotor. In other embodiments, the object detection information can be transmitted to a remote server to produce persistent maps that aggregate information obtained independently from different users. These persistent maps may subsequently serve as a provider of depth data for the originating user or other users. The objection detection information produced in association with the wayfinding and obstacle avoidance system can be used for any number of purposes.

### G. Exemplary Telecommunications Networks

The wayfinding and obstacle avoidance system may be utilized upon any telecommunications network capable of transmitting data including voice data and other types of electronic data. Examples of suitable telecommunications networks for the wayfinding and obstacle avoidance system include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), personal area networks (PAN) and home area networks (HAN). The wayfinding and obstacle avoidance system may communicate via a single telecommunications network or multiple telecommunications networks concurrently. Various protocols may be utilized by the electronic devices for communications such as but not limited to HTTP, SMTP, FTP and WAP (wireless Application Protocol). The wayfinding and obstacle avoidance system may be implemented upon various wireless networks such as but not limited to 3G, 4G, LTE, Wi-Fi, Bluetooth, RFID, CDPD, CDMA, GSM, PDC, PHS, TDMA, FLEX, REFLEX, IDEN, TETRA, DECT, DATATAC, and MOBITEX. The wayfinding and obstacle avoidance system may also be utilized with online services and internet service providers.

The Internet is an exemplary telecommunications network for the wayfinding and obstacle avoidance system. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

At least one embodiment of the wayfinding and obstacle avoidance system is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, the computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the wayfinding and obstacle avoidance system will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the wayfinding and obstacle avoidance system, suitable methods and materials are described above. Thus, the wayfinding and obstacle avoidance system is not intended to be limited to the embodiments shown, but is to be accorded the widest scope consistent with the principles and features disclosed herein.

What is claimed is:

1. A wayfinding and obstacle avoidance device, comprising
a means for obtaining depth data indicating the distance and direction of a plurality of points within a field of view of the device;
a means for providing sensory feedback;
a processor; and
a memory comprising program instructions that when executed by the processor cause the device to:
acquire a point cloud, wherein the point cloud comprises a plurality of points indicating the position t of the plurality of points relative to a plane of reference;
group pluralities of points in the point cloud that are in close proximity to each other;
reject groups containing a number of points below a threshold;
categorize any non-rejected groups as at least part of an object; and
using the means for providing sensory feedback, produce a sensory representation of the presence of at least one object within the field of view of the device.

2. The wayfinding and obstacle avoidance device of claim 1, wherein the means for obtaining depth data comprises:
an infrared emitter; and
an infrared sensor; and
wherein the memory further comprises program instructions that when executed by the processor cause the device to:
emit infrared light using the infrared emitter;
detect reflections of the infrared light using the infrared sensor; and
produce a point cloud utilizing the detected reflections of the infrared light.

3. The wayfinding and obstacle avoidance device of claim 1, wherein the means for providing sensory feedback includes wireless headphones or haptic wristbands.

4. The wayfinding and obstacle avoidance device of claim 1,
wherein the means for providing sensory feedback comprises a visual display comprising a plurality of adjacent sections that correspond to at least a portion of the field of view, and the sensory representation of the position of the at least one object relative to the device comprises the status of at least one of the plurality of adjacent sections.

5. The wayfinding and obstacle avoidance device of claim 1,
wherein the means for providing sensory feedback comprises a vibration motor; and the sensory representation of the position of the at least one object relative to the device comprises vibrating the device at a frequency and intensity that indicates the distance between the at least one object and the device.

6. The wayfinding and obstacle avoidance device of claim 1,
wherein the means for providing sensory feedback comprises an audio output, and the sensory representation of the location of the at least one object relative to the device comprises a plurality of intermittent tones,
wherein the pitch of the intermittent tone indicates the direction of the at least one object relative to the orientation and position of the device; and
wherein at least one of: repetition frequency of the intermittent tone and volume of the intermittent tone indicates the distance between the at least one object and the device.

7. A wayfinding and obstacle avoidance device, comprising:
a means for obtaining pose data indicating the orientation and position of the device;
a means for obtaining depth data indicating the distance and direction of a plurality of points within a field of view of the device;
a means for providing sensory feedback;
a processor; and
a memory comprising program instructions that when executed by the processor cause the device to:
acquire a normalized point cloud, wherein the normalized point cloud comprises a plurality of normalized points indicating the position and height of the plurality of points relative to a plane of reference; and
group pluralities of normalized points in the normalized point cloud that are in close proximity to each other;
reject groups containing a number of normalized points below a threshold;
categorize any non-rejected groups as at least part of an object;
categorize at least one object as matching at least one type within a set of predefined types;
create an area map comprising a representation of the position of the at least one object relative to the device, and at least one type for the at least one object; and
using the means for providing sensory feedback, produce a sensory representation related to the area map.

8. The wayfinding and obstacle avoidance device of claim 7, further comprising:
a means for providing sensory feedback; and
wherein the memory further comprises instructions that when executed by the processor cause the device to:
compare the area map to a previously created area map; and
using the means for providing sensory feedback, produce a sensory representation based on the comparison between the area map and the previously stored area map.

9. The wayfinding and obstacle avoidance device of claim 8,
wherein the set of predefined types comprises high objects, corresponding to objects whose height is greater than a predefined threshold, and low objects, corresponding to objects whose height is lower than a predefined threshold; and
wherein the memory further comprises program instructions that when executed by the processor cause the device to produce a sensory representation related to the position of the at least one object relative to the device and whether the at least one object is a high object or whether the at least one object is a low object.

10. The wayfinding and obstacle avoidance device of claim 9,
wherein the means for providing sensory feedback comprises an audio output, and the sensory representation related to the position of the at least one object relative to the device comprises a plurality of intermittent tones;
wherein the pitch of at least one intermittent tone indicates a direction of the at least one object relative to the device;
wherein the pitch of at least one intermittent tone indicates whether the at least one object is a high object or whether the at least one object is a low object; and
wherein one of: repetition frequency of an intermittent tone and volume of an intermittent tone indicates the distance between the at least one object and the device.

11. The wayfinding and obstacle avoidance device of claim 8, wherein the means for obtaining depth data comprises:
an infrared emitter;
an infrared sensor;
a still image camera; and
wherein the memory comprises instructions that when executed by the processor cause the device to:
measure the time between emission of infrared light by the infrared emitter and detection by the infrared sensor of a reflection of the infrared light emitted by the infrared emitter; and
produce a first point cloud utilizing the measured time;
evaluate an image from the still image camera to determine the position of one or more objects relative to the orientation and position of the device;
produce a second point cloud based on the evaluation;
determine if the number of points in the first point cloud exceeds a threshold;
if the number of points in the first point cloud exceeds the threshold, produce a sensory representation of the position of objects within the first point cloud for at least one object relative to the orientation and position of the device; and
if the number of points in the first point cloud does not exceed the threshold, produce a sensory representation of the position of objects within the second point cloud for at least one object relative to the orientation and position of the device.

12. The wayfinding and obstacle avoidance device of claim 8,
wherein the means for providing sensory feedback comprises a visual display comprising a plurality of adjacent sections that correspond to at least a portion of the field of view, and the sensory representation of the position of the at least one object relative to the device comprises the status of at least one of the plurality of adjacent sections.

13. The wayfinding and obstacle avoidance device of claim 8, wherein the means for providing sensory feedback comprises a vibration motor; and the sensory representation of the position of the at least one object relative to the device comprises vibrating the device at a frequency and intensity that indicates the distance between the at least one object and the device.

14. The wayfinding and obstacle avoidance device of claim 8,
wherein the means for providing sensory feedback comprises an audio output, and the sensory representation of the location of the at least one of the one or more objects relative to the orientation and position of the device comprises a plurality of intermittent tones;
wherein the pitch of the intermittent tone indicates the direction of the at least one object relative to the orientation and position of the device; and
wherein at least one of: repetition frequency of the intermittent tone and volume of the intermittent tone indicates the distance between the at least one object and the device.

15. A wayfinding and obstacle avoidance device, comprising:
an infrared sensor;
an infrared emitter;
a processor;
an audio feedback module; and
a memory comprising program instructions that when executed by the processor cause the device to:
emit infrared light within a field of view using the infrared emitter;
detect reflections of the infrared light using the infrared sensor;
obtain depth data utilizing the detected reflections of the infrared light;
group points of depth data that are in close proximity to each other;
reject groups containing a number of points below a threshold;
categorize any non-rejected groups as an object;
create a grid of true/false values indicating the presence or absence of an object within parallel segments of the field of view; and
provide audio feedback comprising a plurality of intermittent tones each corresponding to at least one of the parallel segments, wherein the pitch of the intermittent tone indicates the presence of at least one object within the corresponding parallel segment, wherein the repetition frequency of the intermittent tone and volume of the intermittent tone indicates the distance between the at least one object and the device.

16. The wayfinding and obstacle avoidance device of claim 15, further comprising a pair of bone-conducting headphones.

17. The wayfinding and obstacle avoidance device of claim 15, wherein the device is a mobile phone.

18. The wayfinding and obstacle avoidance device of claim 15, wherein the device comprises an accelerometer or a gyroscope.
